(19) United States
(12) Patent Application Publication
(10) Pub. No.: US 2025/0141651 A1
(43) Pub. Date: May 1, 2025

(54) REPORTING METHODS, APPARATUSES, DEVICES, AND STORAGE MEDIUMS

(71) Applicant: Beijing Xiaomi Mobile Software Co., Ltd., Beijing (CN)

(72) Inventor: Shengxiang GUO, Beijing (CN)

(21) Appl. No.: 18/838,038

(22) PCT Filed: Feb. 15, 2022
(86) PCT No.: PCT/CN2022/076384

§ 371 Date: Aug. 13, 2024

(51) Int. Cl. H04L 5/14; H04W 72/0453

(52) U.S. Cl. CPC H04L 5/14; H04W 72/0453

(57) ABSTRACT

A reporting method is performed by user equipment (UE), and includes: reporting capability indication information to a network side device, wherein the capability indication information indicates whether frequency bands in a frequency band combination support simultaneous uplink and downlink transmission capability.

### CROSS-REFERENCE TO RELATED APPLICATIONS

The present application is a U.S. National Stage of International Application No. PCT/CN2022/076384, filed on Feb. 15, 2022, the entire disclosure of which is incorporated herein by reference.

### TECHNICAL FIELD

The present disclosure relates to the field of communication technology, and in particular to a reporting method and device/storage medium/apparatus.

### BACKGROUND

In wireless communication systems, such as 4G or 5G communication systems, in order to support higher transmission rates, multi-carrier technologies (such as CA (Carrier Aggregation), DC (Dual Connectivity), EN-DC (E-UTRA-NR Dual Connectivity), etc.) are widely used. However, due to the limitation of the RF hardware on the terminal side, if two frequency bands or two carriers are close to each other, the uplink transmission of one frequency band will affect the downlink reception of another frequency band. This situation generally occurs when the FDD (Frequency Division Duplexing) frequency band and the TDD (Time Division Duplexing) frequency band are aggregated or two TDD frequency bands are aggregated. In the standard, in order to distinguish terminals with different capabilities, the simultaneous uplink and downlink transmission capability (simultaneous Rx/Tx capability) is introduced. However, in the scenario where a plurality of frequency bands are aggregated, especially for some special types of terminals, such as fixed stations, how to let the base station know whether the UE supports simultaneous uplink and downlink transmission capability in a plurality of frequency bands is an urgent problem to be solved.

### SUMMARY

A reporting method provided in one embodiment of the present disclosure is applied to UE, including:

reporting capability indication information to a network side device, wherein the capability indication information is configured to indicate whether frequency bands in a frequency band combination support simultaneous uplink and downlink transmission capability.

A reporting method provided in another embodiment of the present disclosure is applied to a network side device, including:

receiving capability indication information reported by UE, wherein the capability indication information is configured to indicate whether frequency bands in a frequency band combination support simultaneous uplink and downlink transmission capability.

A reporting apparatus provided in one embodiment of the present disclosure includes:

a reporting module, configured to report capability indication information to a network side device, wherein the capability indication information is configured to indicate whether frequency bands in a frequency band combination support simultaneous uplink and downlink transmission capability.

A reporting apparatus provided in another embodiment of the present disclosure includes:

a receiving module, configured to receive capability indication information reported by UE, wherein the capability indication information is configured to indicate whether frequency bands in a frequency band combination support simultaneous uplink and downlink transmission capability.

A communication device provided in another embodiment of the present disclosure includes a processor and a memory, wherein a computer program is stored in the memory, and the processor executes the computer program stored in the memory, to cause the device to execute the method provided in the above one embodiment.

A communication device provided in another embodiment of the present disclosure includes a processor and a memory, wherein a computer program is stored in the memory, and the processor executes the computer program stored in the memory, to cause the device to execute the method provided in the above another embodiment.

A communication device provided in another embodiment of the present disclosure includes: a processor and an interface circuit,

wherein the interface circuit is configured to receive code instructions and transmit the code instructions to the processor;

the processor is configured to execute the code instructions to perform the method according to the above one embodiment.

A communication device provided in another embodiment of the present disclosure includes: a processor and an interface circuit,

wherein the interface circuit is configured to receive code instructions and transmit the code instructions to the processor;

the processor is configured to execute the code instructions to perform the method according to the above another embodiment.

A non-transitory computer-readable storage medium provided in another embodiment of the present disclosure is used to store instructions, and when the instructions are executed, the method provided in the above one embodiment is implemented.

A non-transitory computer-readable storage medium provided in another embodiment of the present disclosure is used to store instructions, and when the instructions are executed, the method provided in the above another embodiment is implemented.

### BRIEF DESCRIPTION OF THE DRAWINGS

The above and/or additional aspects and advantages of the present disclosure will become apparent and easy to understand from the following description of the embodiments in conjunction with the accompanying drawings, wherein:

FIG. 1 is a flowchart of a reporting method provided in an embodiment of the present disclosure;

FIG. 2 is a flowchart of a reporting method provided in another embodiment of the present disclosure;

FIG. 3 is a flowchart of a reporting method provided in yet another embodiment of the present disclosure;

FIG. 4 is a flowchart of a reporting method provided in still another embodiment of the present disclosure;

FIG. 5 is a flowchart of a reporting method provided in still another embodiment of the present disclosure;

FIG. 6 is a flowchart of a reporting method provided in still another embodiment of the present disclosure;

FIG. 7 is a flowchart of a reporting method provided in still another embodiment of the present disclosure;

FIG. 8 is a flowchart of a reporting method provided in still another embodiment of the present disclosure;

FIG. 9 is a schematic diagram of the structure of a reporting apparatus provided in an embodiment of the present disclosure;

FIG. 10 is a schematic diagram of the structure of a reporting apparatus provided in another embodiment of the present disclosure;

FIG. 11 is a block diagram of a user device provided in an embodiment of the present disclosure; and

FIG. 12 is a block diagram of a network side device provided in an embodiment of the present disclosure.

### DETAILED DESCRIPTION

Here, example embodiments will be described in detail, examples of which are shown in the accompanying drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are only examples of apparatuses and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include the plural forms, unless the context clearly indicates other meanings. It should also be understood that, the term “and/or” used herein refers to and includes any or all possible combinations of one or more associated listed items.

It should be understood that although the terms first, second, third, etc. may be used in the embodiments of the present disclosure to describe various information, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” and “in case” as used herein may be interpreted as “at the time of . . . ” or “when . . . ” or “in response to determining”.

The embodiments of the present disclosure are described in detail below, and examples of the embodiments are shown in the accompanying drawings, wherein the same or similar reference numerals throughout represent the same or similar elements. The embodiments described below with reference to the accompanying drawings are exemplary and are intended to be used to explain the present disclosure, and cannot be understood as limiting the present disclosure.

The reporting method and device/storage medium/apparatus provided by the present disclosure are described in detail below with reference to the accompanying drawings.

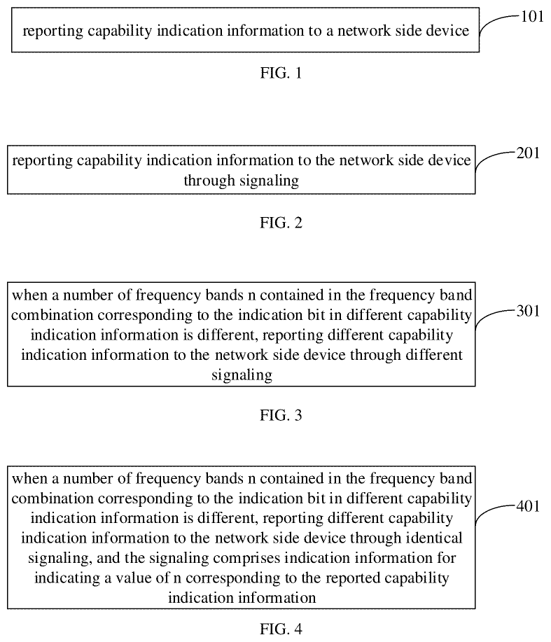

FIG. 1 is a flowchart of a reporting method provided by an embodiment of the present disclosure. The method is performed by UE (User Equipment), as shown in FIG. 1, the reporting method may include the following step:

step 101, reporting capability indication information to a network side device.

In one embodiment of the present disclosure, UE may be a device that provides voice and/or data connectivity to a user. The terminal device can communicate with one or more core networks via RAN (Radio Access Network). The UE can be an IoT terminal, such as a sensor device, a mobile phone (or “cellular” phone), and a computer with an IoT terminal. For example, it can be a fixed, portable, pocket-sized, handheld, computer-built-in, or vehicle-mounted apparatus. For example, a Station (STA), a subscriber unit, a subscriber station, a mobile station, a mobile, a remote station, an access point, a remote terminal, an access terminal, a user terminal, or a user agent. Alternatively, the UE can also be a device of an unmanned aerial vehicle. Alternatively, the UE can also be a vehicle-mounted device, such as a driving computer with a wireless communication function, or a wireless terminal externally connected to a driving computer. Alternatively, the UE can also be a roadside device, such as a street lamp, a signal lamp, or other roadside devices with the wireless communication function.

In one embodiment of the present disclosure, the capability indication information is configured to indicate whether frequency bands in a frequency band combination support simultaneous uplink and downlink transmission capability. Specifically, the capability indication information may include at least one indication bit, each indication bit corresponds to a frequency band (Band) combination, the frequency band combination includes n frequency bands, n≥3, and an indication code carried on the indication bit is used to indicate whether the frequency bands in the frequency band combination corresponding to the indication bit support the simultaneous uplink and downlink transmission capability (simultaneous Rx/Tx capability).

It should be noted that, in one embodiment of the present disclosure, the above frequency band combination is composed of at least any n frequency bands among all frequency bands supported by the UE. Based on this, it is assumed that the total number of frequency bands supported by the UE is m, m≥n, and m is an integer, it can be determined that the number of possible frequency band combinations can be at most Cⁿₘ. Since the indication bit in the capability indication information corresponds to the frequency band combination one by one, the number of indication bits in the above capability indication information should be less than or equal to Cⁿₘ.

It should be noted that, in one embodiment of the present disclosure, the value of n is determined based on the number of frequency bands that support simultaneous uplink and downlink transmission capability reported by the UE. Specifically, if the UE needs to report whether 3 frequency bands support simultaneous uplink and downlink transmission capability, n=3; if the UE needs to report whether 4 frequency bands support simultaneous uplink and downlink transmission capability, n=4.

Further, in one embodiment of the present disclosure, the correspondence between the above frequency band combination and the indication bit can be predetermined by the UE based on the protocol agreement. In one embodiment of the present disclosure, the frequency bands included in the above frequency band combination can be arranged in an order from large to small or from small to large according to the sequence number of the frequency band.

In one embodiment of the present disclosure, that an indication code carried on the indication bit is configured to indicate whether the frequency bands in the frequency band combination corresponding to the indication bit support the simultaneous uplink and downlink transmission capability may include:

when the indication code carried by the indication bit is a first value (for example, 1), it means that the indication code is used to indicate that the frequency bands in the corresponding frequency band combination support the simultaneous uplink and downlink transmission capability;

when the indication code carried by the indication bit is a second value (for example, 0), it means that the indication code is used to indicate that the frequency bands in the corresponding frequency band combination do not support the simultaneous uplink and downlink transmission capability.

For example, in one embodiment of the present disclosure, it is assumed that the total number of frequency bands supported by the UE is m=5, namely Band #0, Band #1, Band #2, Band #3, and Band #4. The UE needs to report whether 3 frequency bands support simultaneous uplink and downlink transmission capability (i.e., n=3). Based on this, by combining any three frequency bands from “Band #0, Band #1, Band #2, Band #3, Band #4”, C³₅=10 band combinations are obtained, which are:
frequency band combination 1: Band #0, Band #1, Band #2;
frequency band combination 2: Band #0, Band #1, Band #3;
frequency band combination 3: Band #0, Band #1, Band #4;
frequency band combination 4: Band #0, Band #2, Band #3;
frequency band combination 5: Band #0, Band #2, Band #4;
frequency band combination 6: Band #0, Band #3, Band #4;
frequency band combination 7: Band #1, Band #2, Band #3;
frequency band combination 8: Band #1, Band #2, Band #4;
frequency band combination 9: Band #1, Band #3, Band #4;
frequency band combination 10: Band #2, Band #3, Band #4.

It is assumed that the UE determines the correspondence between the indication bit in the capability indication information and the frequency band combination based on the protocol agreement as that:
the 0th indication bit corresponds to frequency band combination 1;
the first indication bit corresponds to frequency band combination 2;
the second indication bit corresponds to frequency band combination 3;
the third indication bit corresponds to frequency band combination 4;
the fourth indication bit corresponds to frequency band combination 5;
the fifth indication bit corresponds to frequency band combination 6;
the sixth indication bit corresponds to frequency band combination 7;
the seventh indication bit corresponds to frequency band combination 8;
the eighth indication bit corresponds to frequency band combination 9;
the ninth indication bit corresponds to frequency band combination 10.

Based on this, it is assumed that when the indication code carried by the indication bit is 1, it means that the indication code is used to indicate that the frequency bands in the corresponding frequency band combination support simultaneous uplink and downlink transmission capability. When the indication code carried by the indication bit is 0, it means that the indication code is used to indicate that the frequency bands in the corresponding frequency band combination do not support simultaneous uplink and downlink transmission capability. At this time, if the Bitmap of the capability indication information reported by the network side device is (0111101101), the capability indication information means that: since the indication codes carried by the 0th indication bit, the fifth indication bit and the eighth indication bit are 0, the frequency band combination 1 (Band #0, Band #1, Band #2) corresponding to the 0th indication bit, the frequency band combination 6 (Band #0, Band #3, Band #4) corresponding to the fifth indication bit, and the frequency band combination 9 (Band #1, Band #3, Band #4) corresponding to the eighth indication bit do not support simultaneous uplink and downlink transmission capability; and since the indication codes carried by the first indication bit, the second indication bit, the third indication bit, the fourth indication bit, the sixth indication bit, the seventh indication bit and the ninth indication bit are 1, the frequency band combinations 2, 3, 4, 5, 7, 8, and 10 corresponding to the first indication bit, the second indication bit, the third indication bit, the fourth indication bit, the sixth indication bit, the seventh indication bit and the ninth indication bit all support simultaneous uplink and downlink transmission capability.

In addition, it should be noted that, in one embodiment of the present disclosure, when a certain frequency band combination supports the simultaneous uplink and downlink transmission capability, frequency band sub-combinations corresponding to the frequency band combination also support the simultaneous uplink and downlink transmission capability, wherein the frequency band sub-combinations are combinations of any a frequency bands among the n frequency bands contained in the frequency band combination, 2≤a<n.

For example, in one embodiment of the present disclosure, it is assumed that the frequency band combination six: Band #0, Band #3, Band #4 supports simultaneous uplink and downlink transmission capability, then the frequency band sub-combinations corresponding to frequency band combination six, i.e., sub-combination 1 (Band #0, Band #3), sub-combination 2 (Band #0, Band #4), and sub-combination 3 (Band #3, Band #4) also support simultaneous uplink and downlink transmission capability.

Further, in one embodiment of the present disclosure, the reporting method provided by the present disclosure can be applied to any scenario of carrier aggregation, DC (Dual Connectivity), EN-DC (E-UTRA-NR Dual Connectivity) and MR-DC (Multi RAT Dual Connectivity).

In the reporting method provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

FIG. 2 is a flowchart of a reporting method provided in an embodiment of the present disclosure, which is executed by the UE. As shown in FIG. 2, the reporting method may include the following step:

step 201, reporting capability indication information to the network side device through signaling.

In one embodiment of the present disclosure, the format of the signaling may be the same as the Bitmap in the above embodiment.

In the reporting method and device/storage medium/apparatus provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

FIG. 3 is a flowchart of a reporting method provided in the embodiment of the present disclosure, which is executed by the UE. As shown in FIG. 3, the reporting method may include the following step:

step 301, when a number of frequency bands n contained in the frequency band combination corresponding to the indication bit in different capability indication information is different, reporting different capability indication information to the network side device through different signaling, i.e., when a number of frequency bands n contained in a frequency band combination corresponding to an indication bit in a certain capability indication information is different from a number of frequency bands contained in at least one of other capability indication information, reporting a plurality of signaling, wherein each signaling carries different capability indication information.

For example, in one embodiment of the present disclosure, if the UE needs to report whether 3 frequency bands support simultaneous uplink and downlink transmission capability, such as the UE needs to report whether the 3-frequency-band combination (Band #0, Band #1, Band #2) supports simultaneous uplink and downlink transmission capability, the capability indication information for indicating whether the 3-frequency-band combination (Band #0, Band #1, Band #2) supports simultaneous uplink and downlink transmission capability can be reported to the network side device through signaling 1. If the UE needs to report whether 4 frequency bands support simultaneous uplink and downlink transmission capability, such as the UE needs to report whether the 4-frequency-band combination (Band #3, Band #4, Band #5, Band #6) supports simultaneous uplink and downlink transmission capability, the capability indication information for indicating whether the 4-frequency-band combination (Band #3, Band #4, Band #5, Band #6) supports simultaneous uplink and downlink transmission capability can be reported to the network side device through signaling 2.

In the reporting method provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

FIG. 4 is a flowchart of a reporting method provided in the embodiment of the present disclosure, which is executed by the UE. As shown in FIG. 4, the reporting method may include the following step:

step 401, when a number of frequency bands n contained in the frequency band combination corresponding to the indication bit in different capability indication information is different, reporting different capability indication information to the network side device through identical signaling, and the signaling includes indication information for indicating a value of n corresponding to the reported capability indication information i.e., when a number of frequency bands n contained in a frequency band combination corresponding to an indication bit in a certain capability indication information is different from a number of frequency bands contained in at least one of other capability indication information, reporting one signaling, wherein the signaling contains a plurality of capability indication information, capabilities indicated by the capability indication information are different, and the signaling comprises indication information for indicating a value of n corresponding to the reported capability indication information.

For example, in one embodiment of the present disclosure, if the UE needs to report whether 3 frequency bands support simultaneous uplink and downlink transmission capability, such as the UE needs to report whether the 3-frequency-band combination (Band #0, Band #1, Band #2) supports simultaneous uplink and downlink transmission capability, the capability indication information for indicating whether the 3-frequency-band combination (Band #0, Band #1, Band #2) supports simultaneous uplink and downlink transmission capability can be reported to the network side device through signaling 1, and the signaling 1 includes the indication information for indicating “UE reports whether the 3 frequency bands support simultaneous uplink and downlink transmission capability”. If the UE needs to report whether 4 frequency bands support simultaneous uplink and downlink transmission capability, such as the UE needs to report whether the 4-frequency-band combination (Band #3, Band #4, Band #5, Band #6) supports simultaneous uplink and downlink transmission capability, the capability indication information for indicating whether the 4-frequency-band combination (Band #3, Band #4, Band #5, Band #6) supports simultaneous uplink and downlink transmission capability can be reported to the network side device also through signaling 1, and the signaling 1 includes the indication information for indicating “UE reports whether the 4 frequency bands support simultaneous uplink and downlink transmission capability”.

In the reporting method and device/storage medium/apparatus provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

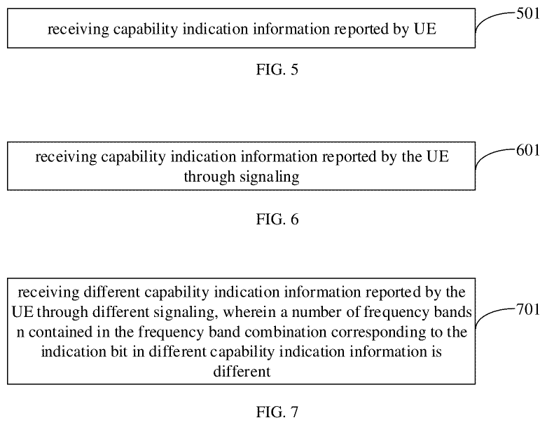

FIG. 5 is a flowchart of a reporting method provided in the embodiment of the present disclosure, which is executed by a network side device. As shown in FIG. 5, the reporting method may include the following step:

step 501, receiving capability indication information reported by the UE.

The capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability.

In one embodiment of the present disclosure, the correspondence between the above frequency band combination and the indication bit can be predetermined by the network side device based on the protocol agreement.

The introduction of step 501 can refer to the description of the above embodiment, and the embodiment of the present disclosure is not limited here.

In the reporting method provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

FIG. 6 is a flowchart of a reporting method provided by an embodiment of the present disclosure, which is executed by a network side device. As shown in FIG. 6, the reporting method may include the following step:

step 601, receiving capability indication information reported by the UE through signaling.

The introduction of step 601 can refer to the description of the above embodiment, and the present disclosure embodiment is not limited here.

In the reporting method provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

FIG. 7 is a flowchart of a reporting method provided by an embodiment of the present disclosure, which is executed by a network side device. As shown in FIG. 7, the reporting method may include the following step:

step 701, receiving different capability indication information reported by the UE through different signaling, wherein a number of frequency bands n contained in the frequency band combination corresponding to the indication bit in different capability indication information is different.

The introduction of step 701 can refer to the description of the above embodiment, and the embodiment of the present disclosure is not limited here.

In the reporting method and device/storage medium/apparatus provided in the embodiment of the present disclosure, the UE will report capability indication information to the network side device, wherein the capability indication information includes at least one indication bit, each indication bit corresponds to a frequency band combination, wherein the capability indication information is used to indicate whether frequency bands in a frequency band combination support simultaneous uplink and downlink transmission capability. Specifically, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

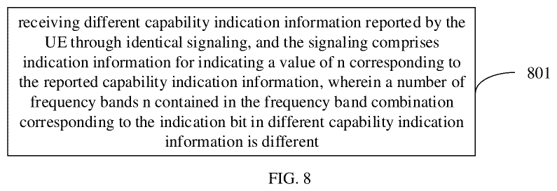

FIG. 8 is a flowchart of a reporting method provided by an embodiment of the present disclosure, and the method is executed by a network side device. As shown in FIG. 8, the reporting method may include the following step:

step 801, receiving different capability indication information reported by the UE through identical signaling, and the signaling includes indication information for indicating a value of n corresponding to the reported capability indication information, wherein a number of frequency bands n contained in the frequency band combination corresponding to the indication bit in different capability indication information is different.

The introduction of step 801 can refer to the description of the above embodiment, and the embodiment of the present disclosure is not limited here.

In the reporting method provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

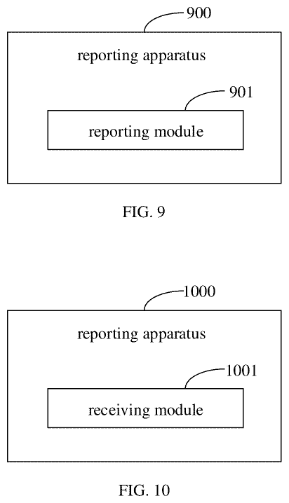

FIG. 9 is a schematic diagram of the structure of a reporting apparatus 900 provided by an embodiment of the present disclosure, which is configured in UE. As shown in FIG. 9, the reporting apparatus may include:

a reporting module 901, configured to report capability indication information to a network side device, wherein the capability indication information is configured to indicate whether frequency bands in a frequency band combination support simultaneous uplink and downlink transmission capability.

In the reporting apparatus provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

Optionally, in an embodiment of the present disclosure, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability.

Optionally, in an embodiment of the present disclosure, a total number of frequency bands supported by the UE is m, m≥n; and a number of the indication bit in the capability indication information is less than or equal to Cⁿₘ.

Optionally, in an embodiment of the present disclosure, that an indication code carried on the indication bit is configured to indicate whether the frequency bands in the frequency band combination corresponding to the indication bit support the simultaneous uplink and downlink transmission capability includes:

when the indication code carried by the indication bit is a first value, the indication code indicating that the frequency bands in the corresponding frequency band combination support the simultaneous uplink and downlink transmission capability;

when the indication code carried by the indication bit is a second value, the indication code indicating that the frequency bands in the corresponding frequency band combination do not support the simultaneous uplink and downlink transmission capability.

Optionally, in one embodiment of the present disclosure, the reporting module is also used to:

report capability indication information to the network side device through signaling.

Optionally, in one embodiment of the present disclosure, the reporting module is also used to:

when a number of frequency bands n contained in the frequency band combination corresponding to the indication bit in different capability indication information is different, report different capability indication information to the network side device through different signaling.

Optionally, in one embodiment of the present disclosure, the reporting module is also used to:

when a number of frequency bands n contained in the frequency band combination corresponding to the indication bit in different capability indication information is different, report different capability indication information to the network side device through identical signaling, and the signaling includes indication information for indicating a value of n corresponding to the reported capability indication information.

Optionally, in one embodiment of the present disclosure, when the frequency band combination supports the simultaneous uplink and downlink transmission capability, frequency band sub-combinations corresponding to the frequency band combination also support the simultaneous uplink and downlink transmission capability, wherein the frequency band sub-combinations are combinations of any a frequency bands among the n frequency bands contained in the frequency band combination, 2≤a<n.

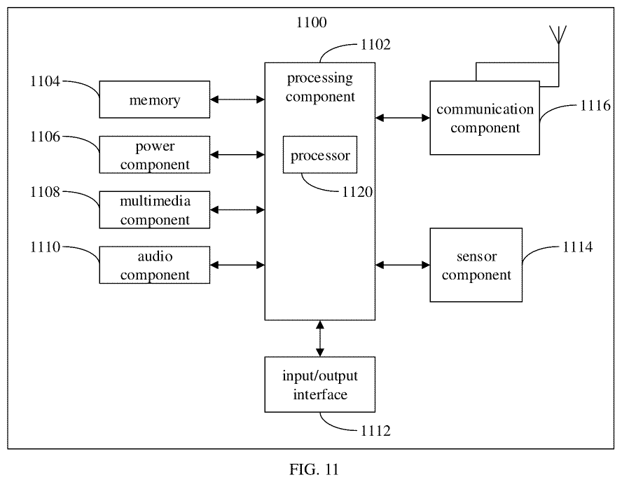

FIG. 10 is a schematic diagram of the structure of another reporting apparatus 1000 provided by an embodiment of the present disclosure, which is configured in a network side device. As shown in FIG. 10, the reporting apparatus may include:

a receiving module 1001, configured to receive capability indication information reported by UE, wherein the capability indication information is configured to indicate whether frequency bands in a frequency band combination support simultaneous uplink and downlink transmission capability.

In the reporting apparatus provided in the embodiment of the present disclosure, the UE reports capability indication information to the network side device, wherein the capability indication information is used to indicate whether frequency bands in a frequency band combination support simultaneous uplink and downlink transmission capability. Specifically, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability. It can be seen that the present disclosure provides a reporting method for indicating whether a plurality of (three or more) frequency bands support simultaneous uplink and downlink transmission capability, which has a wide range of applications.

Optionally, in an embodiment of the present disclosure, the capability indication information includes at least one indication bit, each indication bit corresponds to a frequency band combination, the frequency band combination includes n frequency bands, n≥3, and an indication code carried on the indication bit is used to indicate whether the frequency bands in the frequency band combination corresponding to the indication bit support the simultaneous uplink and downlink transmission capability.

In an embodiment of the present disclosure, a total number of frequency bands supported by the UE is m, m≥n; and a number of the indication bit in the capability indication information is less than or equal to Cⁿₘ.

Optionally, in an embodiment of the present disclosure, that an indication code carried on the indication bit is configured to indicate whether the frequency bands in the frequency band combination corresponding to the indication bit support the simultaneous uplink and downlink transmission capability includes:

when the indication code carried by the indication bit is a first value, the indication code indicating that the frequency bands in the corresponding frequency band combination support the simultaneous uplink and downlink transmission capability;

when the indication code carried by the indication bit is a second value, the indication code indicating that the frequency bands in the corresponding frequency band combination do not support the simultaneous uplink and downlink transmission capability.

Optionally, in an embodiment of the present disclosure, the receiving module is also used to:

receive capability indication information reported by the UE through signaling.

Optionally, in one embodiment of the present disclosure, the receiving module is further used to:

receive different capability indication information reported by the UE through different signaling, wherein a number of frequency bands n contained in the frequency band combination corresponding to the indication bit in different capability indication information is different.

Optionally, in one embodiment of the present disclosure, the receiving module is further used to:

receive different capability indication information reported by the UE through identical signaling, and the signaling includes indication information for indicating a value of n corresponding to the reported capability indication information, wherein a number of frequency bands n contained in the frequency band combination corresponding to the indication bit in different capability indication information is different.

Optionally, in one embodiment of the present disclosure, when the frequency band combination supports the simultaneous uplink and downlink transmission capability, frequency band sub-combinations corresponding to the frequency band combination also support the simultaneous uplink and downlink transmission capability, wherein the frequency band sub-combinations are combinations of any a frequency bands among the n frequency bands contained in the frequency band combination, 2≤a<n.

FIG. 11 is a schematic structural diagram of the UE 1100 provided by an embodiment of the present disclosure. For example, the UE 1100 may be a mobile phone, a computer, a digital broadcast device, a messaging device, a game console, a tablet device, a medical device, a fitness device, a personal digital assistant, etc.

Referring to FIG. 11, the UE 1100 may include at least one of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls the overall operations of the UE 1100, such as the operations associated with display, telephone calls, data communications, camera operations, and recording operations. The processing component 1102 can include one or more processors 1120 to execute instructions to perform all or part of the steps in the above described methods. Moreover, the processing component 1102 can include at least one module to facilitate the interaction between the processing component 1102 and other components. For example, the processing component 1102 can include a multimedia module to facilitate the interaction between the multimedia component 1108 and the processing component 1102.

The memory 1104 is configured to store various types of data to support the operation of the UE 1100. Examples of such data include instructions for any application or method operated on the, such as the contact data, the phone book data, messages, pictures, videos, and the like. The memory 1104 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the UE 1100. The power component 1106 can include a power management system, at least one power source, and other components associated with the generation, management, and distribution of power for the UE 1100.

The multimedia component 1108 includes a screen providing an output interface between the UE 1100 and the user. In some embodiments, the screen can include a liquid crystal display (LCD) and a touch panel (TP). If the screen includes the touch panel, the screen can be implemented as a touch screen to receive input signals from the user. The touch panel includes at least one touch sensor to sense touches, swipes, and gestures on the touch panel. The touch sensors may not only sense a boundary of a touch or swipe action, but also detect the wake-up time and pressure associated with the touch or swipe action. In some embodiments, the multimedia component 1108 includes a front camera and/or a rear camera. When the UE 1100 is in an operation mode, such as a photographing mode or a video mode, the front camera and/or the rear camera can receive external multimedia data. Each of the front camera and the rear camera may be a fixed optical lens system or have focus and optical zoom capability.

The audio component 1110 is configured to output and/or input an audio signal. For example, the audio component 1110 includes a microphone (MIC) configured to receive an external audio signal when the UE 1100 is in an operation mode, such as a call mode, a recording mode, and a voice recognition mode. The received audio signal may be further stored in the memory 1104 or sent via the communication component 1116. In some embodiments, the audio component 1110 also includes a speaker for outputting the audio signal.

The I/O interface 1112 provides an interface between the processing component 1102 and peripheral interface modules, such as keyboards, a click wheels, buttons, and the like. These buttons may include, but not limited to, a home button, a volume button, a starting button, and a locking button.

The sensor component 1114 includes at least one sensor for providing state assessments of various aspects of the UE 1100. For example, the sensor component 1114 can detect an open/closed state of the UE 1100, relative positioning of components, such as the display and the keypad of the UE 1100. The sensor component 1114 can also detect a change in position of one component of the UE 1100 or the UE 1100, the presence or absence of user contact with the UE 1100, an orientation, or an acceleration/deceleration of the UE 1100, and a change in temperature of the UE 1100. The sensor component 1114 can also include a proximity sensor configured to detect the presence of nearby objects without any physical contact. The sensor component 1114 can also include a light sensor, such as a CMOS or CCD image sensor, configured to use in imaging applications. In some embodiments, the sensor component 1114 can also include an accelerometer sensor, a gyroscope sensor, a magnetic sensor, a pressure sensor, or a temperature sensor.

The communication component 1116 is configured to facilitate wired or wireless communication between the UE 1100 and other devices. The UE 1100 can access a wireless network based on a communication standard, such as WiFi, 2G, 3G, or a combination thereof. In an example embodiment, the communication component 1116 receives broadcast signals or broadcast associated information from an external broadcast management system via a broadcast channel. In an example embodiment, the communication component 1116 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an example embodiment, the UE 1100 may be implemented with at least one application specific integrated circuit (ASIC), digital signal processor (DSP), digital signal processing device (DSPD), programmable logic device (PLD), field programmable Gate array (FPGA), controller, microcontroller, microprocessor or other electronic components, to perform the above methods.

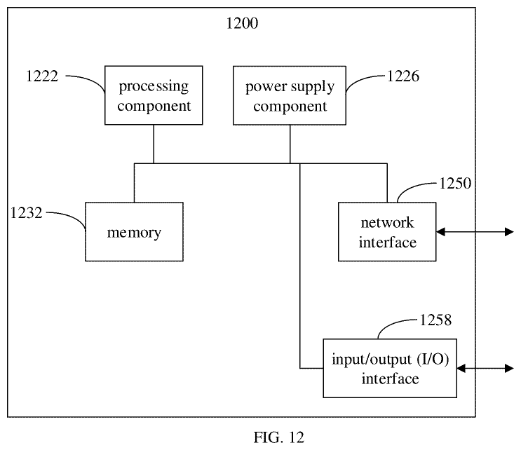

FIG. 12 is a block diagram of a base station 1200 provided in an embodiment of the present application. For example, the base station 1200 may be provided as a base station. Referring to FIG. 12, the base station 1200 may include a processing component 1222, which further includes at least one processor, and memory resources represented by a memory 1232, for storing instructions, such as application programs, that can be executed by processing component 1222. An application stored in memory 1232 may include one or more modules, each of which corresponds to a set of instructions. In addition, the processing component 1222 is configured to execute instructions to execute any of the above methods applied to the base station, for example, the method shown in FIG. 1.

The base station 1200 may also include a power supply component 1226 configured to perform power management of the base station 1200, a wired or wireless network interface 1250 configured to connect the base station 1200 to the network, and an input/output (I/O) interface 1258. The base station 1200 may operate based on an operating system stored in the memory 1232, such as Windows Server™, Mac OS X™, Unix™, Linux™, FreeBSD™ or the like.

In the above embodiments provided by the present disclosure, the methods provided by the embodiments of the present disclosure are introduced from the perspectives of the base station, UE, and RIS array. In order to implement the functions of the methods provided by the above embodiments of the present disclosure, the base station and the UE may include a hardware structure and a software module, and the above functions are implemented in the form of a hardware structure, a software module, or a hardware structure plus a software module. One of the above functions may be executed in the form of a hardware structure, a software module, or a hardware structure plus a software module.

In the above embodiments provided by the present disclosure, the methods provided by the embodiments of the present disclosure are introduced from the perspectives of the base station, UE, and RIS array. In order to implement the functions of the methods provided by the above embodiments of the present disclosure, the network side device and the UE may include a hardware structure and a software module, and the above functions are implemented in the form of a hardware structure, a software module, or a hardware structure plus a software module. One of the above functions may be executed in the form of a hardware structure, a software module, or a hardware structure plus a software module.

A communication device is provided in the embodiments of the present disclosure. The communication device may include a transceiver module and a processing module. The transceiver module may include a sending module and/or a receiving module, the sending module is used to implement the sending function, the receiving module is used to implement the receiving function, and the transceiver module can implement the sending function and/or the receiving function.

The communication device may be a terminal device (such as the terminal device in the above method embodiment), or an apparatus in the terminal device, or an apparatus that can be used in combination with the terminal device. Alternatively, the communication device may be a network device, or an apparatus in the network device, or an apparatus that can be used in combination with the network device.

Another communication device is provided in the embodiment of the present disclosure. The communication device may be a network device, or a terminal device (such as the terminal device in the above method embodiments), or a chip, a chip system, or a processor that supports the network device to implement the above methods, or a chip, a chip system, or a processor that supports the terminal device to implement the above methods. The apparatus may be used to implement the methods described in the above method embodiments, and the details may refer to the description in the above method embodiments.

The communication device may include one or more processors. The processor may be a general-purpose processor or a dedicated processor, or the like. For example, the processor may be a baseband processor or a central processor. The baseband processor can be used to process the communication protocol and the communication data, and the central processor can be used to control the communication device (such as the network side device, the baseband chip, the terminal device, the terminal device chip, the DU or the CU, etc.), execute the computer program, and process the data of the computer program.

Optionally, the communication device may also include one or more memories, on which a computer program may be stored, and the processor executes the computer program, so that the communication device executes the methods described in the above method embodiments. Optionally, data may also be stored in the memory. The communication device and the memory may be provided separately or integrated together.

Optionally, the communication device may also include a transceiver and an antenna. The transceiver may be referred to as a transceiver unit, a transceiver machine, or a transceiver circuit, etc., for realizing the transceiver function. The transceiver may include a receiver and a transmitter, the receiver may be referred to as a receiver machine or a receiving circuit, etc., for realizing the receiving function; the transmitter may be referred to as a transmitter machine or a transmitting circuit, etc., for realizing the transmitting function.

Optionally, the communication device may also include one or more interface circuits. The interface circuit is used to receive the code instruction and transmit it to the processor. The processor runs the code instruction to enable the communication device to execute the methods described in the above method embodiments.

The communication device is a core network device (such as the core network device corresponding to the target UE in the above method embodiments), the processor is used to execute the methods shown in any one of FIGS. 1 to 5.

The communication device is the current service AMF corresponding to the observed UE, the processor is used to execute the methods shown in any one of FIGS. 6 to 7.

The communication device is the LMF corresponding to the observed UE, the processor is used to execute the method shown in FIG. 8.

In one implementation, the processor may include a transceiver for implementing receiving and transmitting functions. For example, the transceiver may be a transceiver circuit, or an interface, or an interface circuit. The transceiver circuit, interface or interface circuit for implementing the receiving and transmitting functions may be separate or integrated. The above transceiver circuit, interface or interface circuit may be used for reading and writing code/data, or the above transceiver circuit, interface or interface circuit may be used for transmitting or delivering signals.

In one implementation, the processor may store a computer program, and the computer program runs on the processor, so that the communication device can perform the methods described in the above method embodiments. The computer program may be solidified in the processor, in which case the processor may be implemented by hardware.

In one implementation, the communication device may include a circuit, the circuit may implement the functions of transmitting or receiving or communicating in the preceding method embodiments. The processors and transceivers described in this disclosure may be implemented on integrated circuits (ICs), analog ICs, radio frequency integrated circuits RFICs, mixed signal ICs, application specific integrated circuits (ASICs), Printed circuit boards (PCBs), electronic devices, etc. The processor and transceiver can also be manufactured by various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (Gas), etc.

The communication device described in the above embodiments may be a network device or a terminal device (for example, the terminal device in the above method embodiments), but the scope of the communication device described in the present disclosure is not limited thereto, and the structure of the communication device may not be limited. The communication device may be a stand-alone device or may be part of a larger device. For example the described communication device may be:
(1) a stand-alone integrated circuit IC, or chip, or, chip system or subsystem;
(2) a collection having one or more ICs, optionally, the collection of ICs may also include storage components for storing data, computer programs;
(3) an ASIC, such as a Modem;
(4) modules that can be embedded within other devices;
(5) receivers, terminal devices, smart terminal devices, cellular phones, wireless devices, handhelds, mobile units, in-vehicle devices, network devices, cloud devices, artificial intelligence devices, and the like;
(6) others, etc.

For the case where the communication device may be a chip or a chip system, the chip includes a processor and an interface. The number of processors may be one or more, and the number of interfaces may be more than one.

Optionally, the chip further includes a memory, the memory is used for storing necessary computer programs and data.

Those skilled in the art may also appreciate that various illustrative logical blocks and steps listed in the embodiments of the present disclosure may be implemented by electronic hardware, computer software, or a combination of both. Whether such function is implemented by hardware or software depends on the particular application and the design requirements of the overall system. A person skilled in the art may use a variety of methods to implement the described function for each particular application, but such implementations should not be construed as being going beyond the scope of protection of embodiments of the present disclosure.

The present disclosure also provides a readable storage medium having stored thereon instructions which, when executed by a computer, realize the functions of any of the foregoing method embodiments.

The present disclosure also provides a computer program product which realizes the function of any of the above-described method embodiments when executed by a computer.

In the above embodiments, this may be realized in whole or in part by software, hardware, firmware, or any combination thereof. When implemented using software, it may be implemented in whole or in part in the form of a computer program product. The computer program product includes one or more computer programs. When loading and executing the computer program on a computer produces, a process or function in accordance with embodiments of the present disclosure is generated in whole or in part. The computer may be a general purpose computer, a specialized computer, a computer network, or other programmable devices. The computer program may be stored in a computer-readable storage medium or transmitted from one computer-readable storage medium to another computer-readable storage medium. For example, the computer program may be transmitted from a web site, computer, server, or data center via a wired (e.g., coaxial cable, fiber optic, digital subscriber line (DSL)) or wireless (e.g., infrared, wireless, microwave, etc.) to another website site, computer, server, or data center. The computer-readable storage medium can be any available medium that a computer can access or a data storage device such as a server, a data center and the like that contains one or more available media integration. The usable medium may be a magnetic medium (e.g., floppy disk, hard disk, magnetic tape), an optical medium (e.g., high-density digital video disc (DVD)), or a semiconductor medium (e.g., solid state disk (SSD)) and the like.

A person of ordinary skill in the art may understand that the first, second, and other various numerical numbers involved in the present disclosure are only for the convenience of description, and are not used to limit the scope of the embodiments of this disclosure, but also indicate the order.

The at least one in the present disclosure may also be described as one or more, and the plurality may be two, three, four, or more, which is not limited by the present disclosure. In embodiments of the present disclosure, for a technical feature, a technical feature is described by “first”, “second”, “third”, “A ”, “B”, “C”, and “D”, etc., to distinguish the technical features in the kind of technical features, technical features described with the “first”, “second”, “third”, “A”, “B”, “C”, and “D” are not in any order of precedence or magnitude.

Other embodiments of the present disclosure will easily occur to those skilled in the art after considering the specification and practicing the disclosure disclosed herein. The present disclosure is intended to cover any variation, use or adaptation of the present disclosure, which follows the general principles of the present disclosure and includes common sense or common technical means in the technical field not disclosed in this disclosure. The specification and embodiments are to be regarded as example only, with the true scope and spirit of the disclosure being indicated by the attached claims.

It should be understood that the present disclosure is not limited to the precise structure described above and shown in the drawings, and various modifications and changes can be made without departing from its scope. The scope of the present disclosure is limited only by the appended claims.

1. A reporting method, performed by user equipment (UE), comprising:
reporting capability indication information to a network side device, wherein the capability indication information indicates whether frequency bands in a frequency band combination support simultaneous uplink and downlink transmission capability.

2. The method according to claim 1, wherein the capability indication information comprises at least one indication bit, each indication bit corresponds to a frequency band combination, the frequency band combination comprises n frequency bands, n≥3, and an indication code carried on the indication bit indicates whether the frequency bands in the frequency band combination corresponding to the indication bit support the simultaneous uplink and downlink transmission capability.

3. The method according to claim 1, wherein a total number of frequency bands supported by the UE is m, m≥n; and a number of the indication bit in the capability indication information is less than or equal to Cⁿₘ.

4. The method according to claim 2, wherein the indication code carried on the indication bit indicating whether the frequency bands in the frequency band combination corresponding to the indication bit support the simultaneous uplink and downlink transmission capability comprises:
in response to determining that the indication code carried by the indication bit is a first value, the indication code indicating that the frequency bands in the corresponding frequency band combination support the simultaneous uplink and downlink transmission capability; and
in response to determining that the indication code carried by the indication bit is a second value, the indication code indicating that the frequency bands in the corresponding frequency band combination do not support the simultaneous uplink and downlink transmission capability.

5. The method according to claim 1, wherein reporting capability indication information to a network side device comprises:
reporting capability indication information to the network side device through signaling.

6. The method according to claim 5, wherein reporting capability indication information to the network side device through signaling comprises:
in response to determining that a number of frequency bands n contained in a frequency band combination corresponding to an indication bit in a first piece of capability indication information is different from a number of frequency bands contained in at least one second piece of capability indication information, reporting a plurality of signalings, wherein each signaling carries different capability indication information.

7. The method according to claim 5, wherein reporting capability indication information to the network side device through signaling comprises:
in response to determining that a number of frequency bands n contained in a frequency band combination corresponding to an indication bit in a first piece of capability indication information is different from a number of frequency bands contained in at least one second piece of capability indication information, reporting one signaling, wherein the signaling contains a plurality of pieces of capability indication information, capabilities indicated by the plurality of pieces of capability indication information are different, and the signaling comprises indication information for indicating a value of n corresponding to the reported capability indication information.

8. The method according to claim 1, wherein in response to that the frequency band combination supports the simultaneous uplink and downlink transmission capability, frequency band sub-combinations corresponding to the frequency band combination also support the simultaneous uplink and downlink transmission capability, wherein the frequency band sub-combinations are combinations of any a frequency bands among the n frequency bands contained in the frequency band combination, 2≤a<n.

9. A reporting method, performed by a network side device, comprising:
receiving capability indication information reported by user equipment (UE), wherein the capability indication information indicates whether frequency bands in a frequency band combination support simultaneous uplink and downlink transmission capability.

10. The method according to claim 9, wherein the capability indication information comprises at least one indication bit, each indication bit corresponds to a frequency band combination, the frequency band combination comprises n frequency bands, n≥3, and an indication code carried on the indication bit indicates whether the frequency bands in the frequency band combination corresponding to the indication bit support the simultaneous uplink and downlink transmission capability.

11. The method according to claim 9, wherein a total number of frequency bands supported by the UE is m, m≥n; and a number of the indication bit in the capability indication information is less than or equal to Cⁿₘ.

12. The method according to claim 9, wherein the indication code carried on the indication bit indicating whether the frequency bands in the frequency band combination corresponding to the indication bit support the simultaneous uplink and downlink transmission capability comprises:
in response to determining that the indication code carried by the indication bit is a first value, the indication code indicating that the frequency bands in the corresponding frequency band combination support the simultaneous uplink and downlink transmission capability; and
in response to determining that the indication code carried by the indication bit is a second value, the indication code indicating that the frequency bands in the corresponding frequency band combination do not support the simultaneous uplink and downlink transmission capability.

13. The method according to claim 9, wherein receiving capability indication information reported by UE comprises:
receiving capability indication information reported by the UE through signaling.

14. The method according to claim 13, wherein receiving capability indication information reported by the UE through signaling comprises:
receiving different capability indication information reported by the UE through different signaling, wherein a number of frequency bands n contained in the frequency band combination corresponding to the indication bit in different capability indication information is different.

15. The method according to claim 13, wherein receiving capability indication information reported by the UE through signaling comprises:
receiving different capability indication information reported by the UE through identical signaling, and the signaling comprises indication information for indicating a value of n corresponding to the reported capability indication information, wherein a number of frequency bands n contained in the frequency band combination corresponding to the indication bit in different capability indication information is different.

16. The method according to claim 9, wherein in response to that the frequency band combination supports the simultaneous uplink and downlink transmission capability, frequency band sub-combinations corresponding to the frequency band combination also support the simultaneous uplink and downlink transmission capability, wherein the frequency band sub-combinations are combinations of any a frequency bands among the n frequency bands contained in the frequency band combination, 2≤a<n.

17. (canceled)

18. (canceled)

19. A communication device, comprising:
a processor; and
a memory storing a computer program executable by the processor;
wherein the processor is configured to:
report capability indication information to a network side device, wherein the capability indication information indicates whether frequency bands in a frequency band combination support simultaneous uplink and downlink transmission capability.

20. A communication device, comprising:
a processor; and
a memory storing a computer program executable by the processor;
wherein the processor is configured to perform the method according to claim 9.

21. (canceled)

22. (canceled)

23. A non-transitory computer-readable storage medium, having instructions stored thereon, wherein when the instructions are executed by a processor, the processor is caused to perform the method according to claim 1.

24. A non-transitory computer-readable storage medium, having instructions stored thereon, wherein when the instructions are executed by a processor, the processor is caused to perform the method according to claim 9.
